(19) United States
(12) Patent Application Publication
(10) Pub. No.: US 2010/0082358 A1
(43) Pub. Date: Apr. 1, 2010

(54) GENERATION OF FORMAL SPECIFICATIONS OF TRADING PARTNER AGREEMENTS

(75) Inventors: CHRISTOPHE BEGUE, San Francisco, CA (US); Keeranoor Kumar, Randolph, NJ (US); Mark H. Linehan, Yorktown Heights, NY (US); Prabir Nandi, Duluth, GA (US); Vishwanath Narayan, Boca Raton, FL (US)

Correspondence Address: FLEIT GIBBONS GUTMAN BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 12/242,130

(22) Filed: Sep. 30, 2008

(51) Int. Cl. G06Q 30/00

(52) U.S. Cl. 705/1

(57) ABSTRACT

Systems and methods are provided for generating a formal specification of a trading partner agreement for sharing between trading partners. The trading partner agreement that is established between at least two of the trading partners is analyzed. A set of contracts, a set of protocols, and a set of service level agreements associated with the trading partner agreement is identified. A single formal specification of the trading partner agreement is generated. The single formal specification comprises the set of contracts, the set of protocols, and the set of service level agreements using a markup language. Each of the set of contracts, the set of protocols, and the set of service level agreements are expressed in a markup language notation. The single formal specification is usable by multiple trading partners.

### CROSS-REFERENCE TO RELATED APPLICATIONS

This application is related to application “Automatic Determination of Selective Message Caching To Support Rules in a Trading Partner Collaboration Management Environment,” Ser. No. ______, Attorney Docket No. YOR920080539US1, now ______, and application “Automatically Generating User Interfaces in a Trading Partner Collaboration Management Environment,” Ser. No. ______, Attorney Docket No. YOR920080540US1, now ______, which were filed on the same day as the present application and commonly assigned therewith to International Business Machines Corporation. These related applications are incorporated herein by reference in their entirety.

### FIELD OF THE INVENTION

The present invention generally relates to the field of trading partner collaboration management, and more particularly relates to generating formal specifications of trading partner agreements that can be shared between trading partners.

### BACKGROUND OF THE INVENTION

The Internet has allowed companies to exploit electronic communications to engage in Business-to-Business (B2B) transactions with other companies. B2B transactions involve conducting business operations such as buying and selling goods and services over the Internet with trading or business partners. Trading partners are businesses that exchange goods or services for value. For example, trading partners can be a manufacturer and a raw goods supplier that supplies the manufacturer.

In B2B environments trading partners usually have trading agreements established with each other. Trading partner agreements generally cover a wide range of issues which include the enforcement of contracts, protocols, and service level agreements (SLAs) on B2B transactions. A business typically utilizes one or more trading partner management systems for managing B2B transactions with its trading partners. These systems are generally directed to defining, configuring, executing, and monitoring the business's B2B transactions and adherence of those transactions to trading partner agreements.

However, in many instances trading partners have implemented disparate systems to diversify the number of available B2B channels for B2B transactions. Because these disparate systems are deployed among trading partners, trading partner collaboration management is difficult with conventional trading partner management systems. Also, conventional trading partner management systems generally do not provide a convenient and efficient way to establish trading agreements and B2B processes with trading partners with differing supply chain models. Another problem with these conventional trading partner management systems is that they usually do not provide support for common collaboration processes and business rules in the context of heterogeneity of B2B connectivity protocols and standards. Another drawback of conventional trading partner management systems is that B2B integrations with small and medium sized business partners that have extremely limited B2B capabilities and IT budgets are difficult to establish. Further, conventional trading partner management systems generally do not provide an improvement in the quality of B2B data in the face of many manual processes for message creation and the need for conformance to several business rules and trading partner agreements.

### SUMMARY OF THE INVENTION

One embodiment of the present invention provides a method for generating a formal specification of a trading partner agreement for sharing between trading partners. According to the method, the trading partner agreement that is established between at least two of the trading partners is analyzed. A set of contracts, a set of protocols, and a set of service level agreements associated with the trading partner agreement is identified. A single formal specification of the trading partner agreement is generated. The single formal specification comprises the set of contracts, the set of protocols, and the set of service level agreements using a markup language. Each of the set of contracts, the set of protocols, and the set of service level agreements are expressed in a markup language notation. The single formal specification is usable by the plurality of trading partners.

Another embodiment of the present invention provides an information processing system for generating a formal specification of a trading partner agreement for sharing between trading partners. The information processing system includes a memory and a processor that is communicatively coupled to the memory. A trading partner collaboration manager is communicatively coupled to memory and the processor. The trading partner collaboration manager is adapted to analyze the trading partner agreement that is established between at least two of the trading partners. A set of contracts, a set of protocols, and a set of service level agreements associated with the trading partner agreement is identified. A single formal specification of the trading partner agreement is generated. The single formal specification comprises the set of contracts, the set of protocols, and the set of service level agreements using a markup language. Each of the set of contracts, the set of protocols, and the set of service level agreements are expressed in a markup language notation. The single formal specification is usable by the plurality of trading partners.

A further embodiment of the present invention provides a computer program product for generating a formal specification of a trading partner agreement for sharing between trading partners. The computer program product includes instructions for analyzing the trading partner agreement that is established between at least two of the trading partners. A set of contracts, a set of protocols, and a set of service level agreements associated with the trading partner agreement is identified. A single formal specification of the trading partner agreement is generated. The single formal specification comprises the set of contracts, the set of protocols, and the set of service level agreements using a markup language. Each of the set of contracts, the set of protocols, and the set of service level agreements are expressed in a markup language notation. The single formal specification is usable by the plurality of trading partners.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a block diagram illustrating an operating environment in accordance with one embodiment of the present invention;

FIG. 2 is a block diagram illustrating a detailed view of an enterprise information processing system according to one embodiment of the present invention;

FIG. 3 is a logical view of a partner collaboration design process according to one embodiment of the present invention;

FIGS. 4-6 illustrate exemplary state transition models according to one embodiment of the present invention;

FIG. 7 shows a state transition model that is customized based on a protocol rule according to one embodiment of the present invention;

FIG. 8 shows the markup language notation of the customized state transition model of FIG. 7 according to one embodiment of the present invention;

FIG. 9 shows a state transition model that is customized based on a service level agreement rule according to one embodiment of the present invention;

FIG. 10 shows the markup language notation of the customized state transition model of FIG. 9 according to one embodiment of the present invention;

FIG. 11 shows a state transition model that is customized based on a contract rule according to one embodiment of the present invention;

FIG. 12 shows the markup language notation of the customized state transition model of FIG. 11 according to one embodiment of the present invention;

FIG. 13 is a flow diagram illustrating a process for generating a formal specification of a trading partner agreement according to one embodiment of the present invention;

FIG. 14 is a block diagram illustrating an information processing system that is useful for implementing embodiments of the present invention; and

FIG. 15 is a hierarchical view of functional layers and modules of a trading partner collaboration management environment according to one embodiment of the present invention.

### DETAILED DESCRIPTION

Exemplary embodiments of the present invention will be described in detail hereinbelow with reference to the attached drawings.

Embodiments of the present invention generate formal specifications of a trading partner agreement that address the implications of the agreement on Business-to-Business (B2B) messages. A markup language is utilized that enables the creation of a single machine readable formal specification that can express all trading partner agreement related aspects which impact B2B messages between the trading partners. This formal specification is sharable between multiple trading partners.

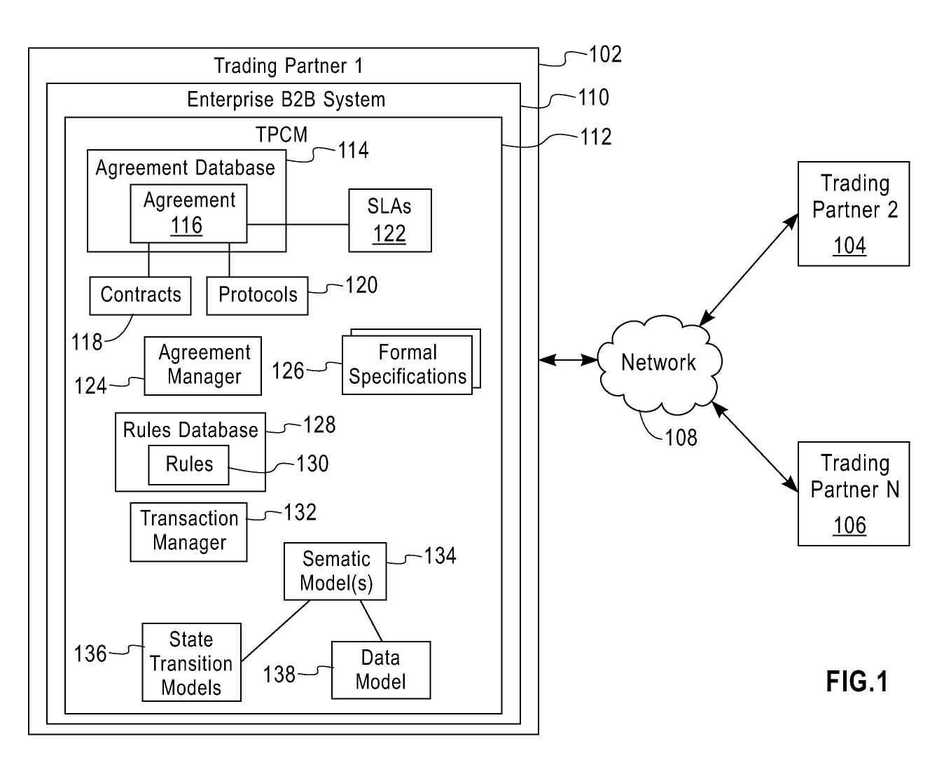

FIG. 1 is a block diagram illustrating an operating environment according to one embodiment of the present invention. The operating environment includes a number of trading partners 102, 104, and 106 that are communicatively coupled to each other via one or more networks 108. Trading partners are businesses that exchange goods and/or services for value. Each trading partner 102, 104, and 106 utilizes one or more information processing systems, such as an enterprise system 110, for performing, among other things, B2B transactions.

In this embodiment, the exemplary enterprise system 110 includes a trading partner collaboration manager (TPCM) 112 that includes a trading partner agreement database 114. This database 114 includes multiple trading partner agreements 116 between the business 102 implementing the TPCM 112 and its trading partners 104 and 106. A trading partner agreement 116 includes one or more contracts 118, protocols 120, and service level agreements (SLAs) 122. The TPCM 112 also includes an agreement manager 124 for managing agreements 116 and transforming agreements and their components 118, 120, and 122 into a formal specification 126 that is shareable between the trading partners 102, 104, and 106. The TPCM 112 also includes a rules database 128 having one or more business rules 130 associated with the trading partners 102, 104, and 106.

The TPCM 112 also includes a trading partner transaction manager 132 (or in further embodiments the TPCM 112 itself acts as a transaction manager). The transaction manager 132 manages the organization and coordination of trading partner activities between the trading partner 102 implementing the TPCM 112 and the other trading partners 104 and 106. For example, the transaction manager 132 manages activities such as (but not limited to) negotiations (e.g., establishing terms and conditions for collaboration), orders (and order changes or cancellations), shipment notifications, invoicing and payments, and exception handling (such as errors, damaged goods, and delays).

The transaction manager 132 further manages trading partner processes, business rules, message exchange and integration, and partner collaboration solutions. Trading partner process management includes supporting stateful conversational exchange of information between trading partners and enabling dynamic negotiations to determine mutually acceptable values of business parameters. Business rule management includes enforcing trading partner agreements by governing the admissibility of message transmission, intended negotiation step, and message business content in a context dependent way. Business rule management also includes enabling conditions that govern message routing, or events for measuring key performance indicators (KPIs). Message and exchange integration management includes supporting automated and user-interaction-centric mechanisms to exchange B2B messages and supporting integration of B2B public processes and business rules with enterprise private processes and edge applications. Message and exchange integration management also includes performing data transformations necessary to address variability of B2B and backend data formats. Partner collaboration solution management includes monitoring of the B2B processes and message flows for tracking KPIs and exceptional behavior.

The transaction manager 132 also maintains and manages a transaction information history cache. The transaction history cache includes information that is mutually shared by the trading partners 102, 104, and 106 and that is used in the execution of business rules related to new transactions. The transaction management operations of the TPCM 112, such as selective caching of transaction data into a transaction history cache and B2B message management utilizing automatically generated user interfaces, are discussed in greater detail in related applications “Automatic Determination of Selective Message Caching To Support Rules in a Trading Partner Collaboration Management Environment” and “Automatically Generating User Interfaces in a Trading Partner Collaboration Management Environment”.

The TPCM 112 performs trading partner collaboration management operations that involve supporting all capabilities of the business 102 implementing the TPCM 112 that are related to supply chain partner collaboration. For example, the TPCM 112 exchanges supply chain transactions between the trading partners 102, 104, and 106. The TPCM 112 dynamically negotiates and determines mutually acceptable values of business parameters between the trading partners 102, 104, and 106. The TPCM 112 can also enforce trading partner agreements 116. These trading partner agreements 116 manifest themselves as context dependent rules that govern the admissibility of message transmissions, negotiations, and message business content.

The TPCM 112 also performs data transformations to address the constraints that trading partners 102, 104, and 106 have with regard to the B2B formats that each can create and process. In this embodiment, multiple user-driven as well as automated mechanisms are supported by the TPCM 112 to exchange B2B messages. The TPCM 112 can also implement processes and rules related to trading partner agreements 116 and negotiations to be orthogonal to B2B message exchange formats and mechanisms.

The TPCM 112 supports (either automatically or semi-automatically) the trading partner agreements 116. Trading partner agreements 116 cover a wide range of issues, which include the enforcement of contracts 118, protocols 120, and SLAs 122 on trading partner B2B messages. Contracts 118 are legal agreements between the businesses that include financial and business terms and conditions concerning the operation aspects of the trade. Examples contracts 118 are “when an order is split by a seller at least 50% of quantity must have the original delivery date”, and “seller cannot quote different ‘price’ for the same item when the order is split”.

Protocols 120 include information exchange permissibility and sequencing/timing rules. Examples of protocols 120 are “seller can only counter a change request by the buyer”, and “when buyer makes changes to ‘quantity’ the seller is allowed to make changes to the delivery date”. SLAs 122 include performance and quality of service related rules that pertain to responsiveness, timeliness, and effectiveness. An example of a performance SLA is “at least 80% of the orders which are within forecast limits must be shipped on time”. An example of a quality SLA is “Account #, Item #, and Currency code must belong to registered value for this partner and there must not be more than 6 violations in a 6 month period”.

In addition to supporting trading partner agreements, the TPCM 112 generates a formal specification 126 of a trading partner agreement in a markup language that can be shared between the trading partners 102, 104, and 106. This formal specification 126 expresses, in a single formal expression, the impact of contracts 118, protocols 120, and SLAs 122 as a composition of collaboration models and business rules that constrain the agreements 116.

Thus, the TPCM 112 formally specifies (or expresses) a partner collaboration agreement 116, which includes contracts 118, protocols 120, and SLAs 122 that impact the activity of message exchange and the underlying business transactions supported by the message exchange. This formal specification 126 includes an expression of the admissible trading partner interaction patterns at the message exchange, collaboration, and business transaction levels, together with rules 130 that govern the transitions in each pattern. These rules 130 use a shared canonical semantic model 134 as their foundation in order to achieve the expressibility that is needed. The rules 118 are constructed on this semantic model 134, which expresses historical and current message data together with message structure. The formal specification 126 is created by one trading partner 102 and can be shared with the other trading partners 104 and 106. The trading partners 102, 104, and 106 are able to import formal specifications 126 from each other into their own partner collaboration environment 112.

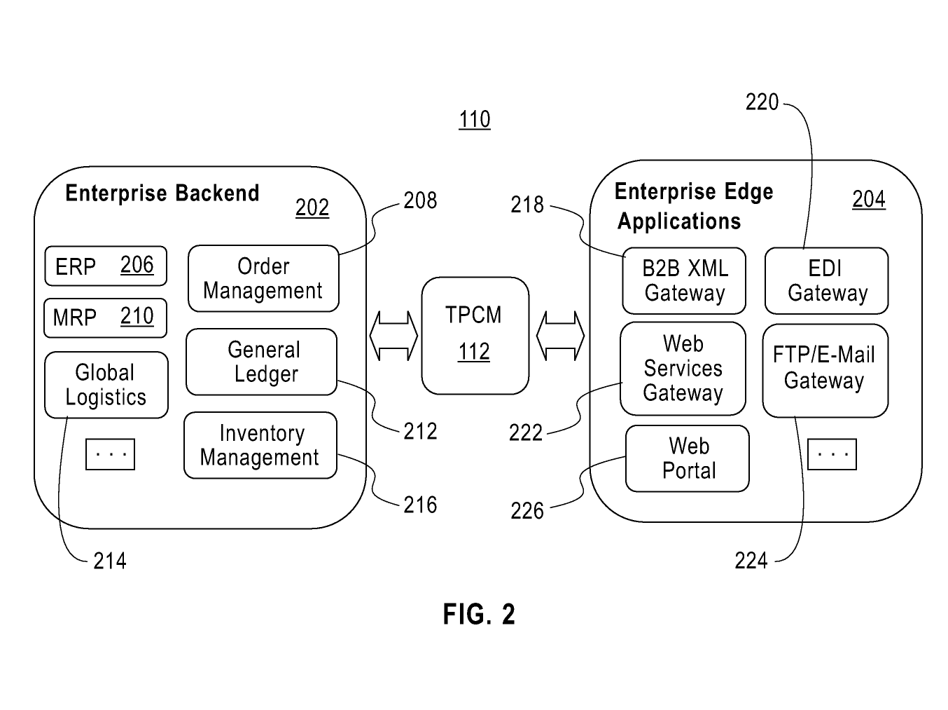

FIG. 2 is a block diagram illustrating a more detailed view of the enterprise system of FIG. 1. As shown, the enterprise system 110 includes an enterprise backend 202 and an enterprise edge 204. The enterprise backend 202 includes various systems that perform associated business operations. For example, the enterprise backend 202 of this exemplary embodiment includes an Enterprise Resource Planning (ERP) system 206, an order management system 208, a Materials Requirement Planning (MRP) system 210, a general ledger system 212, a global logistics system 214, and an inventory management system 216. In further embodiments, the enterprise backend can include different systems.

The enterprise edge 204 includes various gateway applications 218-226 that interface with the other trading partners 104 and 106. The gateway applications 218-226 can either be fully automated (e.g., B2B XML, EDI (Electronic Data Interchange), or Web services) or partially automated (Web Portal or FTP/Email). In further embodiments, the enterprise edge can include different applications from those shown in FIG. 2. The enterprise edge gateways 218-226 of this embodiment provide the following functions: message format conversion (such as XML-based Trading Partner messages to/from SAP or other enterprise backend software), message routing (such as routing a purchase order (PO) message to a Backend System or routing advanced shipping notices (ASNs) to a Backend System), low-level message content validation (such as requiring that an ID field must not be empty or that the total number of line items must be between 1 and 10), and human interfacing (portal) for use by trading partners that do not support electronic trading (with the portal converting between electronic messages and “forms” (e.g., XForms) on the screen).

In this embodiment, the transaction manager 112 is situated between the enterprise edge 204 and the enterprise backend 202 for managing trading partner collaboration operations and for creating formal specifications of trading partner agreements that can be shared between the trading partners. The TPCM 112 provides trading partner administrators with design-time capabilities for authoring, importing, and/or exporting formal agreement specifications 126 in a markup language such as (but not limited to) eXtensible Markup Language (XML), Structured English Expression supported by a supply chain domain ontology based on the Semantics of Business Vocabulary and Business Rules (SBVR) standard, and the like.

Each formal specification 126 constitutes a single machine readable specification that expresses contracts 118, protocols 120, and SLAs 122 as they relate to trading partner B2B messages. The TPCM 112 also provides runtime operations to intercept trading partner B2B messages and enforce contracts 118, protocols 120, and SLAs 122, and to handle related exceptions. These runtime operations are based on the trading partner agreements 116 (generated as a formal specification 126) established between a business 102 implementing the TPCM 112 and its trading partners 104 and 106.

While some trading partner collaboration management systems provide B2B conversation support to try and formally specify complex trading processes (for example, one example of B2B conversation support offers open-ended exchange of messages between two or more parties with both client and server acting as peers), these systems have limitations. For example, although the rules which govern state transitions in a conversational model can be (theoretically speaking) built on any type of data including current message content, historical transaction data, and static data, a systematic method has not been developed to easily incorporate such rules into best-practice conversation models for a supply chain domain.

This is because conversation systems usually do not maintain historical transaction data. Also, the design philosophy of being independent of backend integrations and applications causes these systems to not be designed for integration with backend information databases. Further, conversation system tooling does not have a mechanism to build rules depending on the business semantics of transactions or express dependencies between current messages and prior messages, which are linked by business semantics of transactions. Also, conversation system state models generally do not currently have techniques for systematically incorporating rules involving business semantics of transactions as model extensions.

Additionally, contracts, protocols, and SLAs are linked by the underlying business requirements, which are a common basis for all three. Existing mechanisms for supporting different aspects of trading partner agreements, including new results such as conversation support, fall short of offering a single integrated solution that can use a single integrated machine readable specification of trading partner agreement implications on B2B messages. This is because dealing with the contracts and SLAs necessitates the inclusion of rules, which relate to the deeper semantics of a transaction. Even further, although notations are easy to find for expressing state machines, business rules, and their combinations within the context of well defined business processes, notations do not currently exist for expressing state transitions constrained by rules defined on a semantic model that uses historical and current message data together with message structure.

This embodiment of the present invention, on the other hand, addresses all implications of trading partner agreements 116 on B2B messages within a single enterprise application module residing between the enterprise edge 204 and its backend 202. The TPCM 112 utilizes a markup language that enables the creation of one single machine readable specification 126 that can express all trading partner agreement 116 related aspects which impact B2B messages between trading partners, including contracts 118, protocols 120, and SLAs 122. The notation utilized by the TPCM 112 when creating the formal specification 126 is able to express collaboration state transitions constrained by rules 130 that are defined on a semantic model 134. This semantic model 134 uses historical and current message data together with message structure, and applies this information to the formal specification 126 creation process. The TPCM 112 also enables trading partner agreements 116 to be created and exchanged in a human readable form (especially for business contracts to be signed) and converted to the machine readable form, and vice versa. In some embodiments, this is performed using standards such as SBVR for expressing rules in structured English with the underlying domain of discourse expressed formally by collaboration state transitions constrained by rules 130 defined on a semantic model 134 that uses historical and current message data together with message structure.

Thus, the TPCM 112 generates a universally understood specification 126 for trading partner agreements 116 by utilizing a shared ontology for supply chain partner collaboration messages and data entities of interest. The TPCM markup language, in this embodiment, is based on this shared semantic model 134 that includes universally understood supply chain state transition models and their relationship to underlying data entities. The semantic model 134 includes canonical supply chain state transition models 136 and underlying data models 138. The triggering of the state transition models 136 results in changes to B2B transactional content and states expressed in the underlying data model 138.

The semantic model 134, in this embodiment, includes three cooperating layers of state transition models 136 and data models 138 that support them: a transactional layer supported by a transactional data model cache, a collaboration layer supported by a collaboration data model cache, and a message exchange layer supported by a message exchange data model cache. Some aspects of the semantic model 134 can be predefined such as the transactional, collaborative, and message exchange layers, and other aspects can be specified by administrators through the TPCM 112 (such as a specific data model for a particular trading partner).

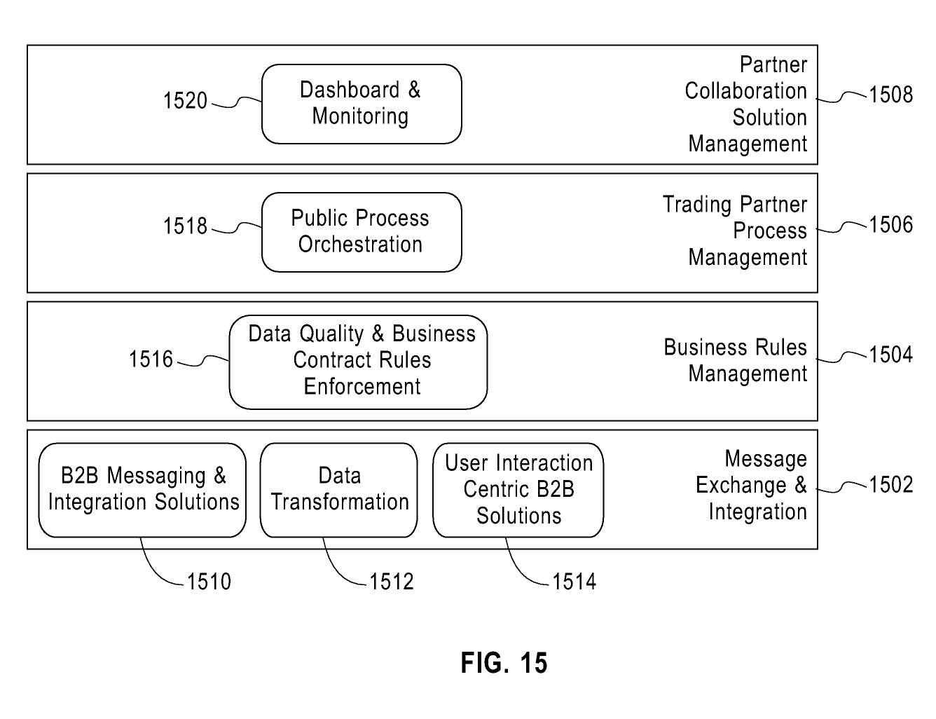

FIG. 15 shows a hierarchical view of the various cooperating/functional layers according to one embodiment of the present invention. In particular, FIG. 15 shows a Message Exchange and Integration layer 1502 at the lowest layer, then moving upwards there is a Business Rules Management layer 1504, a Trading Partner Process Management layer 1506, and a Partner Collaboration Solution Management layer 1508. The Message Exchange and Integration layer 1502 carries three application and partner integration functionality related modules. The first is the B2B Messaging and Integration Solutions module 1510 that offers the capabilities for machine-to-machine B2B messaging with support for standard formats and protocols such as Electronic Data Interchange (EDI) over Applicability Statement 2 (AS2), RosettaNet over RosettaNet Implementation Framework (RNIF), etc. This module also offers integration with backend applications and edge applications over Java Message Service (JMS), Message Queue (MQ), Web services, etc.

The second module 1512 is the User Interaction Centric B2B Solutions module that offers capabilities for manual message inspection and construction with built-in support for ensuring conformance with message validity and business rules. The third module 1514 is the Data Transformation module that offers the support for transforming backend and partner facing data formats to the canonical format of the framework and does also include data aggregation and de-aggregation support.

The Business Rules Management layer 1504 carries a Data Quality and Business Contract Rules Enforcement module 1516 that supports the rules at runtime to detect data inaccuracy and business exceptions and to generate triggers for special actions, complex event management, and KPI measurement. The Trading Partner Process Management layer 1506 (e.g., transactional layer) carries Public Process Orchestration modules 1518 that supports the runtime state machine with associated actions underlying all the TPCM activities involving message delivery, exception handling, and solution management functions. The Partner Collaboration Solution Management layer 1508 (e.g., collaboration layer) carries a Dashboard and Monitoring module 1520 that supports solution management involving the displays of key business status and system KPIs, and capabilities for exception management.

The data model 138 captures essential supply chain B2B transactional content and state information. For example, a data model 138 can include field names and semantic meanings at each of the message exchange, collaboration, and transaction layers. The data model content is equivalent to vocabularies the Semantics of Business Vocabularies and Business Rules (SBVR) standard or ontologies in Web Ontology Language (OWL). Reference schemes can be included in a data model 138 to uniquely identify (i.e., by specifying primary lookup keys) messages and message contents. A data model 138 can also include static information such as trading partner identifiers and web addresses. State information such as “PO received and not responded to” can also be included in a data model 138.

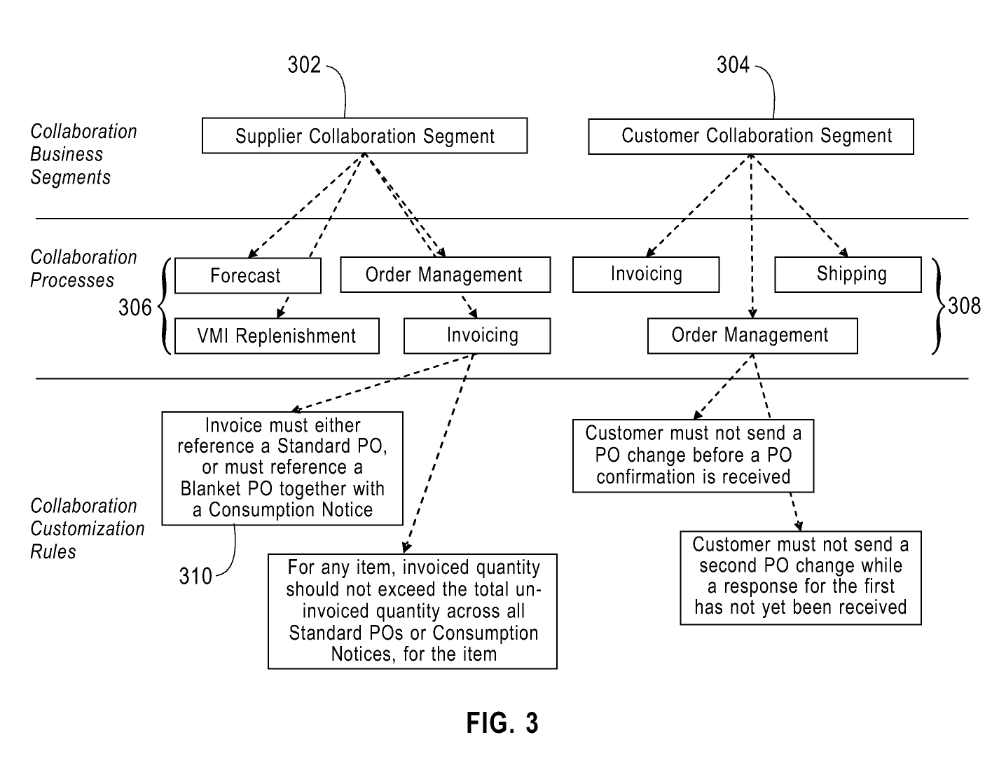

To generate a formal specification 126 relating to a trading partner collaboration agreement, a trading partner administrator analyzes the enterprise's total Supply Chain Collaboration Objectives and logically partitions the solution scope into Collaboration Business Segments. FIG. 3 shows an example of designing trading partner collaborations associated with both the processing of orders from customers and the placement of orders with suppliers in accordance with one embodiment of the present invention. As shown, the designer has partitioned the solution scope into a supplier collaboration segment 302 and a customer collaboration segment 304. This partitioning can be based on preferred business groupings along the lines of products, partners, and/or geographies.

The designer, via the TPCM 112, then identifies and customizes the Collaboration Processes for each Collaboration Business Segment. In the example of FIG. 3, for the supplier collaboration segment 302, the designer has identified collaboration processes 306 of forecast, order management, VMI replenishment, and invoicing. For the customer collaboration segment 304, the designer has identified collaboration processes 308 of invoicing, shipping, and order management. The TPCM 112 enables the import and creation of new processes and modification of predefined processes. Also, the TPCM 112 can include a library of predefined Collaboration Process assets modeled on best-practices.

The designer, via the TPCM 112, then creates as needed for each Collaboration Process Collaboration Customization Rule 130 which describes customizations of message exchange protocols and conditions placed on message content. In the example of FIG. 3, a collaboration customization rule 310 for the invoicing collaboration process is “Invoice must either reference a Standard PO, or must reference a Blanket PO together with a Consumption Notice”. Collaboration customization rules can relate to contracts 118, protocols 120, and SLAs 122. The TPCM 112 enables the expression of rules 130 using highly intuitive mechanisms such as structured English and/or diagrams. Also, a library of predefined Collaboration Customization Rule assets representing a collection of the most frequently associated rules for a given Collaboration Process can also be made available to the designer by the TPCM 112. Message definitions (content and structure) are canonical and implicit within the collaboration process and collaboration customization rule designing processes.

A formal specification 126 of the trading partner agreement is then created based on the design process discussed above. The TPCM 112 uses this formal specification 126 to implement the Collaboration Processes and Collaboration Customization Rules and behaves as per the desired set of customization choices. An alternate way of configuring the TPCM 112 is to import the formal specification 126 generated separately (such as by a trading partner) into the TPCM 112. After the importing process, the TPCM 112 includes all of the Collaboration Processes and Collaboration Customization Rules as defined by the original author.

The TPCM 112 generates a formal specification 126 of trading partner agreements using a markup language by expressing collaboration protocol aspects of partner agreements using state machines. This is captured in markup language notation specifications using, for example, State Chart XML and the notation for expressing state machines (as described on the Internet at www.w3.org/TR/2005/WD-scxml-20050705). The TPCM 112 of this embodiment utilizes multi-layered state machines which express B2B collaborations at three levels of abstraction: the message layer, collaboration layer, and transaction layer.

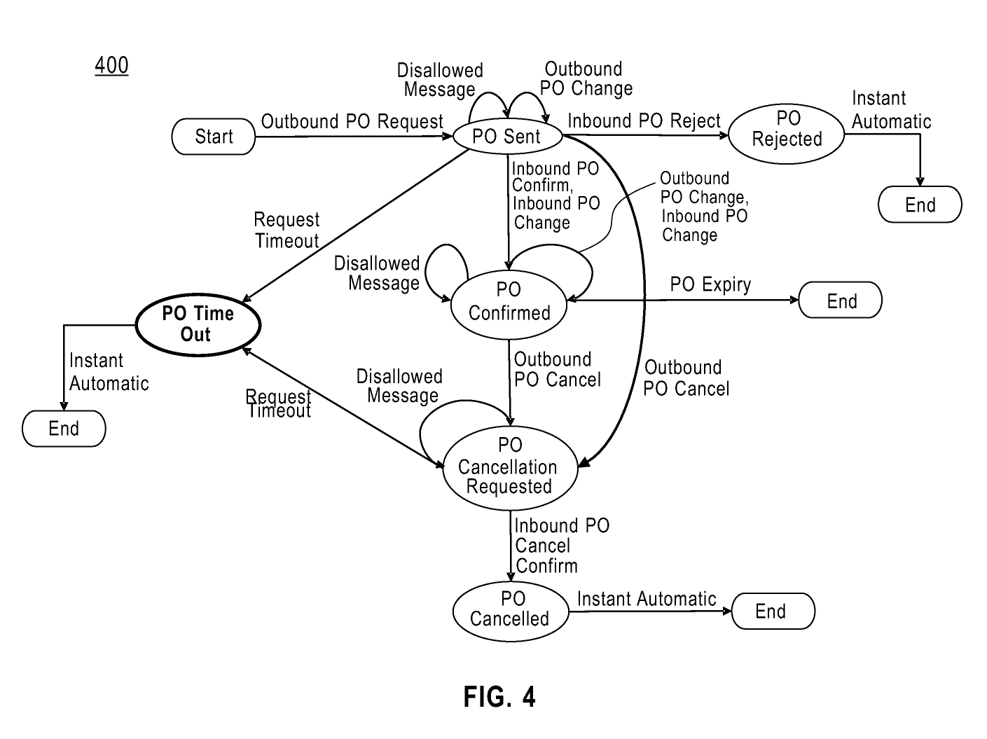

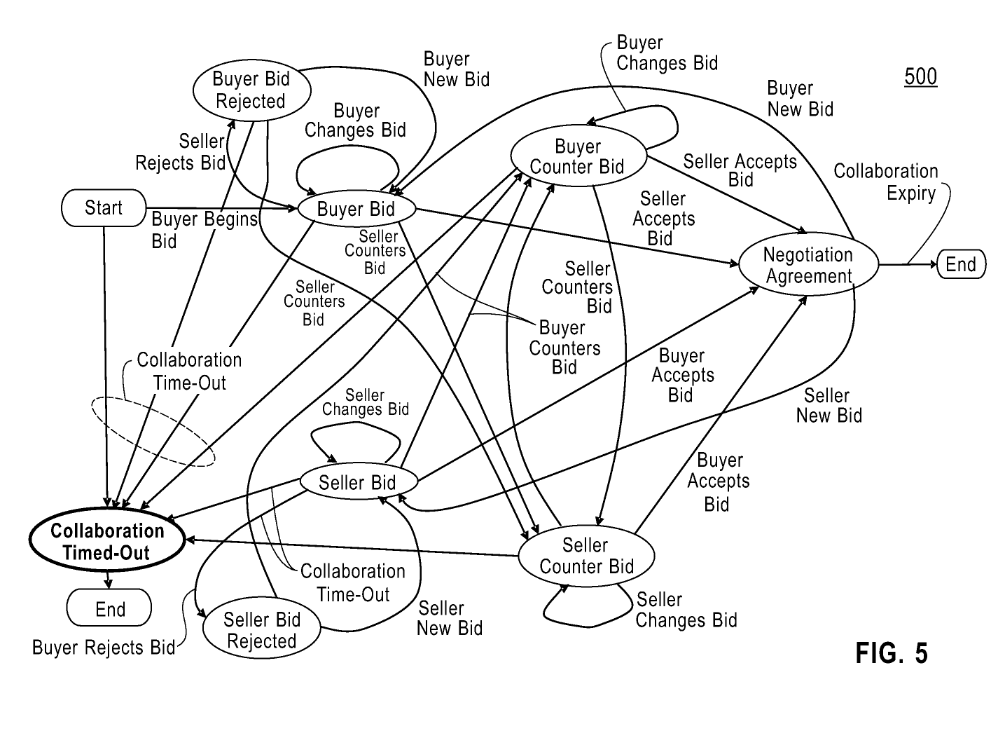

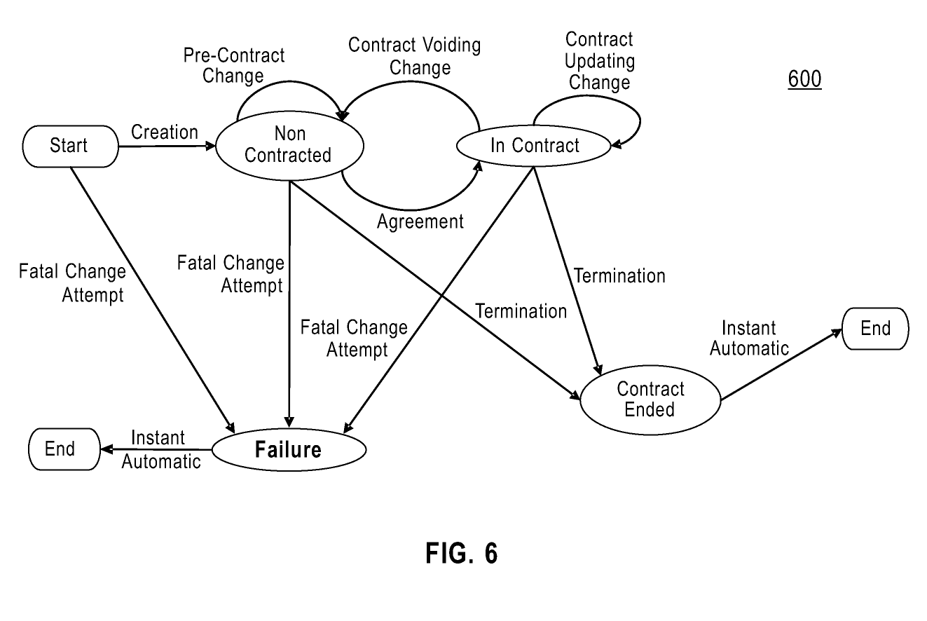

The TPCM 112 models contract and SLA related rules as conditions built on “canonical events” that guard transitions in the above described state machines. FIGS. 4-6 show exemplary state transition models according to one embodiment of the present invention. These examples show a message exchange layer state machine 400 (PO state transition example for a buyer) and related canonical message events, a collaboration layer state machine 500 (PO LI collaboration state transition example for a buyer) and related canonical collaboration events, and a transactional layer state machine 600 (PO LI element state transition example) and related canonical transactional events. These related rules are associated with the state machine at the appropriate layer to express the rule in question.

For every rule, a new transition is generally introduced at design time to capture the exception situation when the guard condition fails, and this transition is associated with the exception action. The rules make references to historical transaction information (as discussed in the related application) in addition to static and state information. These references are made by using a notation suitable for making references to objects and their parts within the business domain. For example, ontology notations such as OWL can be used.

The rules 130 can customize the state transition models 400, 500, and 600 at all three layers of the semantic model 134. The rules 130 can add “exception” or “special action” events to the canonical event set of each layer. This results in associated new transitions being added to the corresponding state transition models. When rules are introduced as message filtering conditions against one of the standard canonical events, the TPCM 112 automatically introduces (at design time) an exception event which signals the failure of the rule. When rules are introduced to identify a special event (such as a large order or an urgent order) which calls for special handling, the TPCM 112 enables the introduction (at design time) of special action events that signal the occurrence of the event.

The following is an example of the TPCM 112 handling a protocol rule, and uses a protocol rule of “PO must be confirmed by seller before other transactions by buyer or seller”. This protocol rule can be transformed into the following pseudo code:

```
if (PO State == “PO Sent”) then
  if Message Event is neither Inbound PO Confirm nor Inbound PO
    Reject then create PO Not-Confirmed Exception event
```

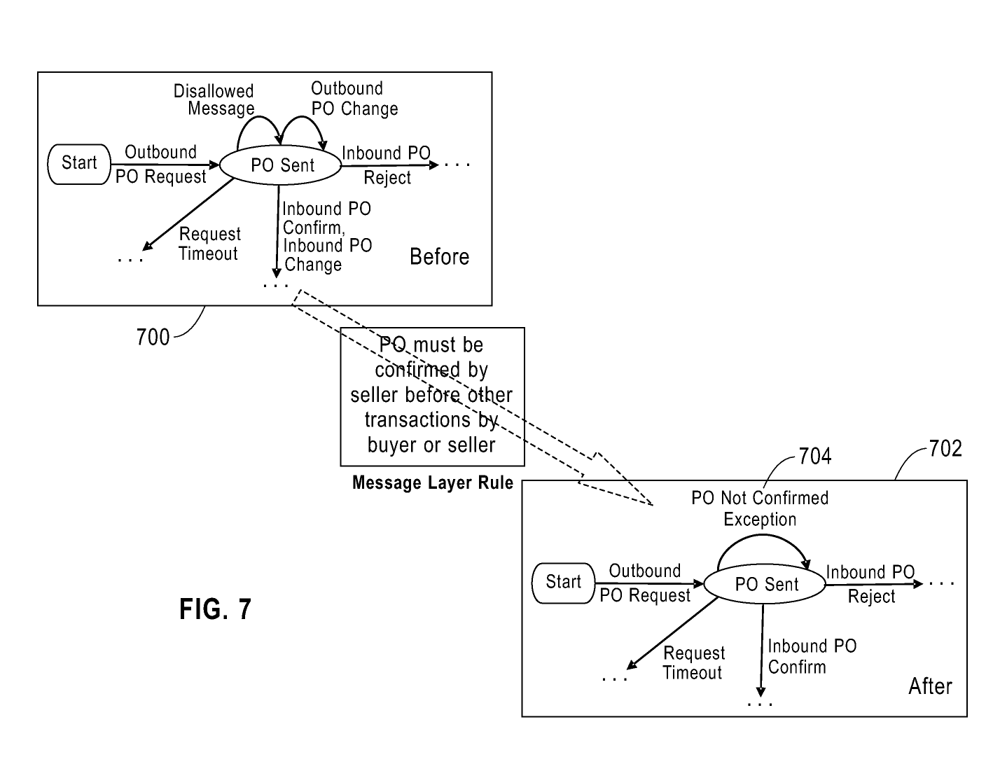

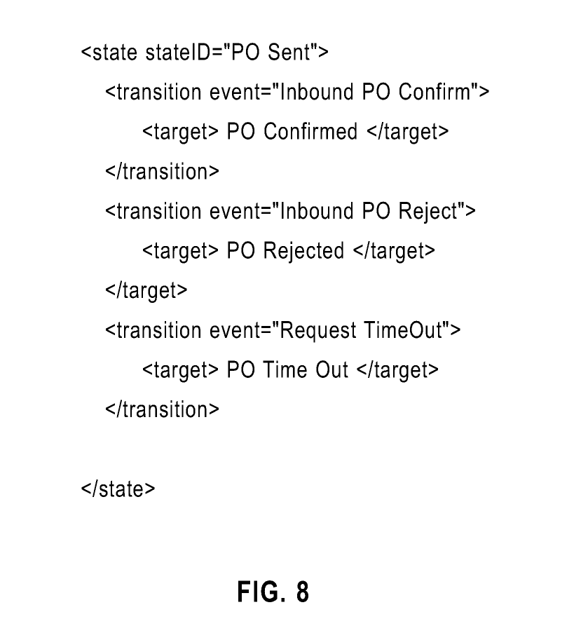

This protocol rule constrains the message layer state transition model as well as introduces an additional transition to capture the exception situation. Also, because this rule involves sequencing, the TPCM 112 handles this rule by modifying the state machine without guard rules. FIG. 7 shows an initial message layer state model and a customized message layer model based on the above protocol rule in accordance with one embodiment of the present invention. As shown, the TPCM 112 has customized the initial state model 700 with a new transition 704 resulting in the customized state model 702. The TPCM 112 then generates a formal specification 800 of the message layer state model using a markup language such as XML, as shown in FIG. 8.

The following is an example of the TPCM 112 handling an SLA rule, and uses an SLA rule of “Partner must respond to Forecasts within 1 week”. This SLA rule can be transformed into the following pseudo code:

```
if (Transactional State == (“Non-Contracted”) then
  if Transaction Event is either Pre-Contract Change or Agreement then
    if Forecast_response_message.creation_date exceeds
    Forecast_message.creation_date by more than 7 days then
      create Forecast Response Delay Exception event
```

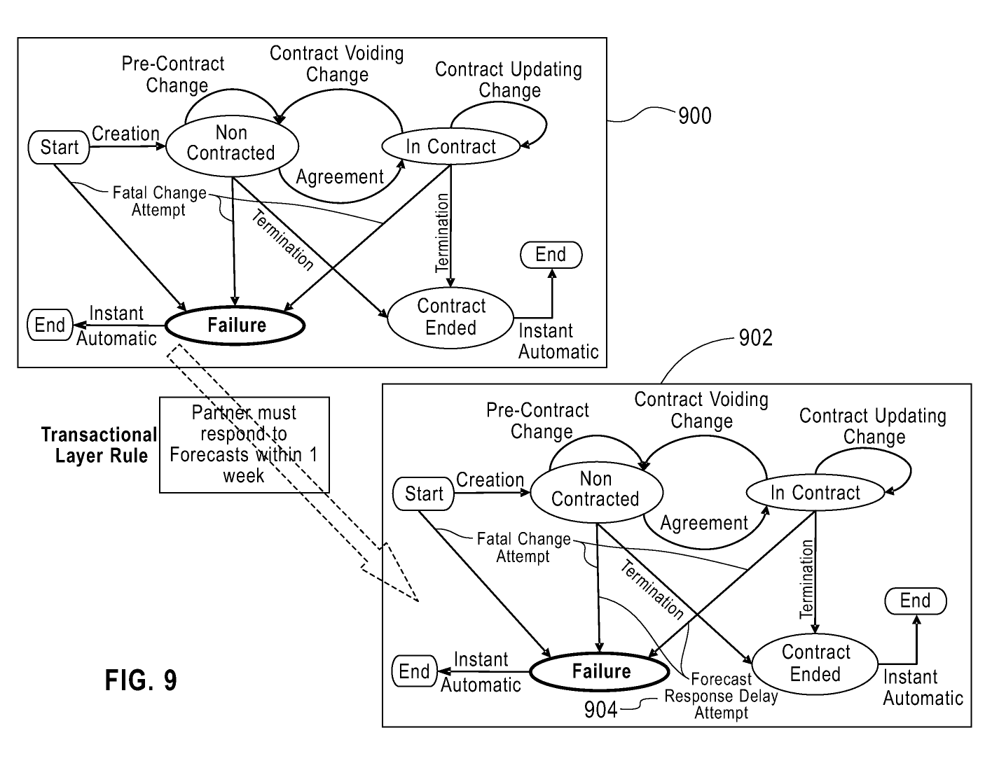

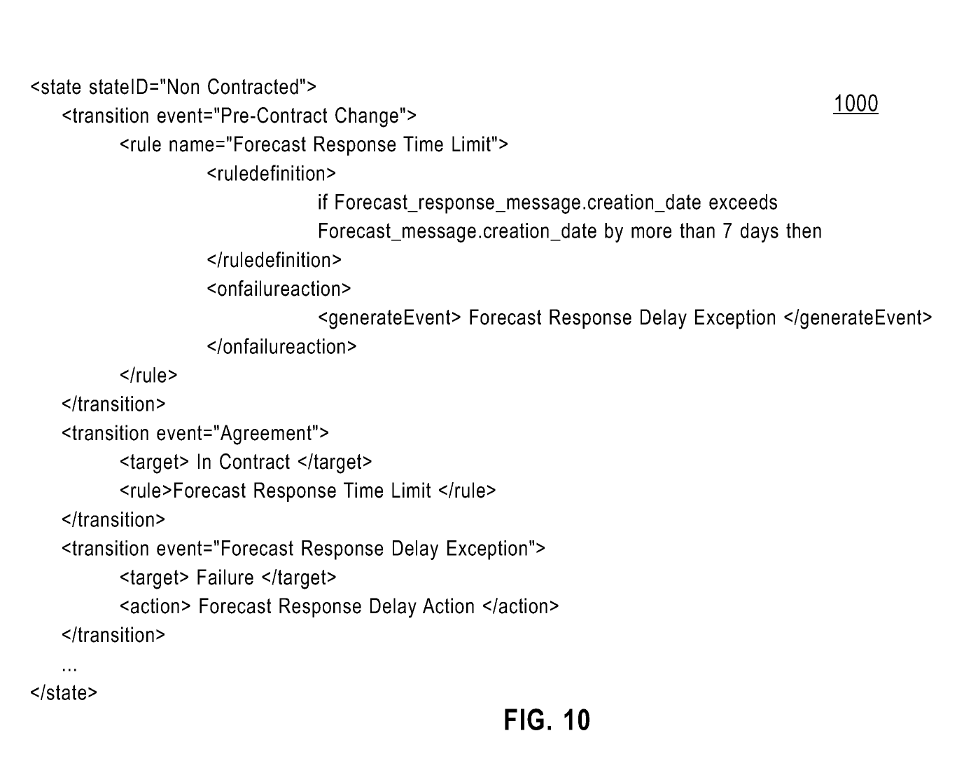

This SLA rule creates a guard on a transition in the transactional layer state model which is established against the data objects in the semantic model 134. Also, this SLA rule adds an additional transition to the transactional layer to capture the exception situation. FIG. 9 shows an initial transactional layer state model and a customized transactional layer model based on the above SLA rule in accordance with one embodiment of the present invention. As shown, the TPCM 112 has customized the initial state model 900 with a new transition 904 resulting in the customized state model 902. The TPCM 112 then generates a formal specification 1000 of the message layer state model using a markup language such as XML, as shown in FIG. 10. In FIG. 10, rules appear as guard conditions for transitions, with the rules themselves expressed using SBVR notation.

The following is an example of the TPCM 112 handling a contract rule, and uses a contract rule of “Seller changes to ‘delivery date’ cannot exceed the ‘original requested delivery date’ by more than 2 weeks”. This contract rule can be transformed into the following pseudo code:

```
if (Transactional State == (“Non-Contracted” or “In Contract”)) then
  if Transaction Event is either Pre-Contract Change or Contract Updating
  Change or Contract Voiding Change then
      if POLI_message.delivery_date exceeds
      POLI_original_requested_delivery_date by more than 14 days
          then create Delivery Date Exceeds 2 Week Limit Exception
          event
```

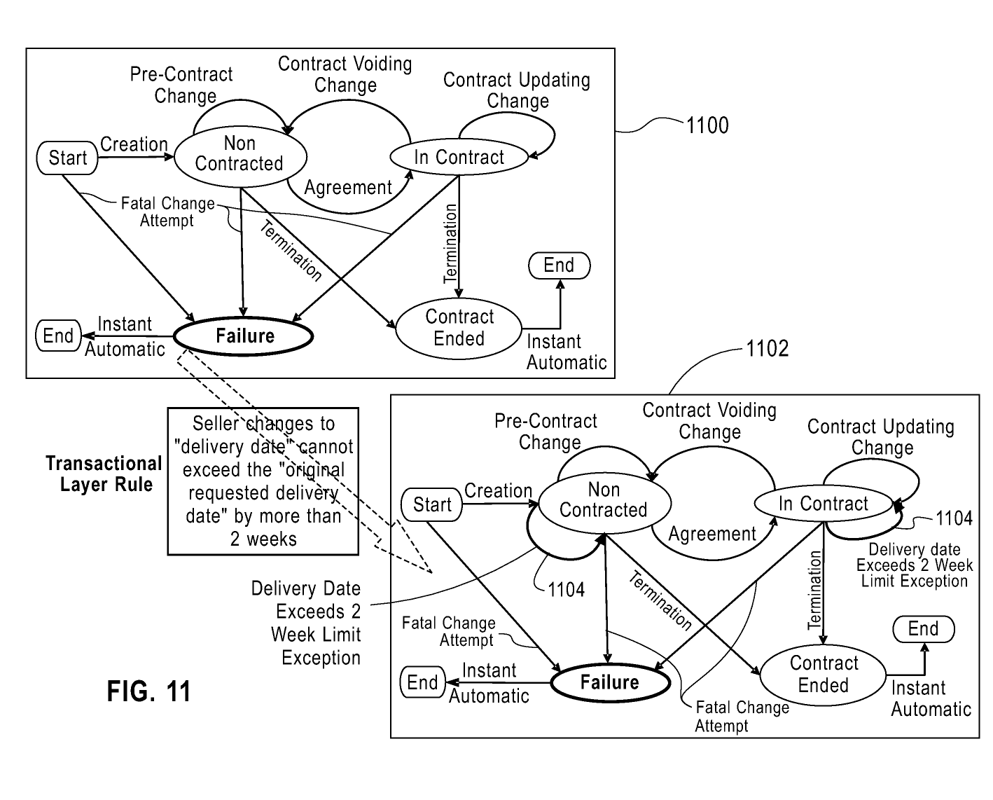

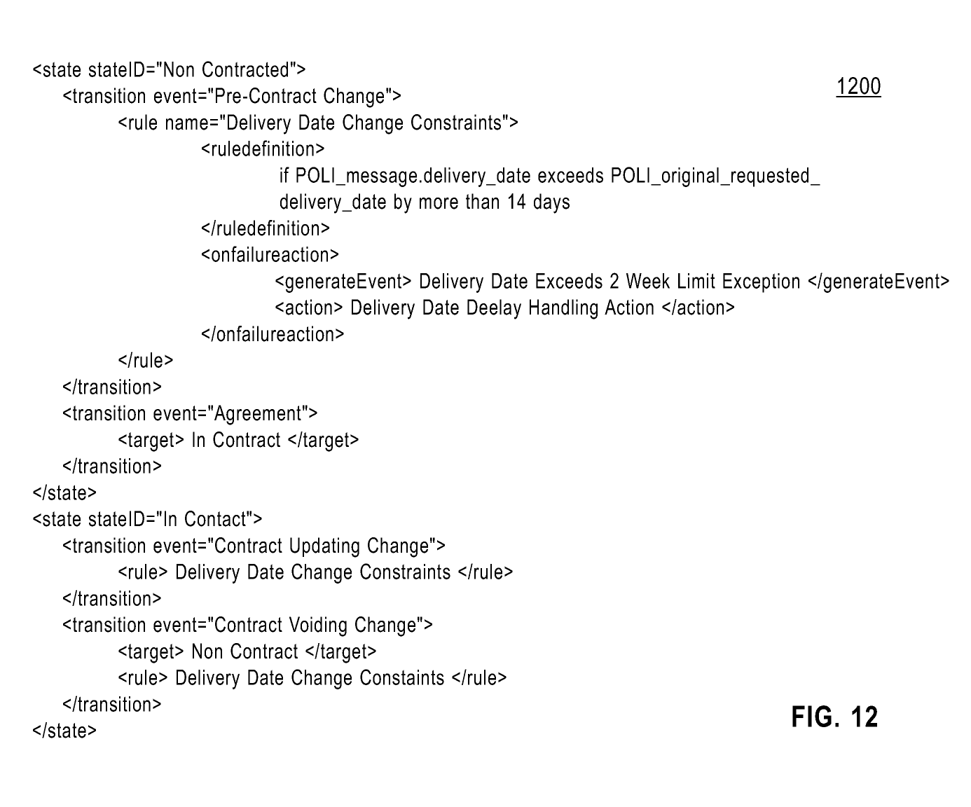

This contract rule creates a guard on multiple transitions in the transactional layer state model which is established against the data objects in the semantic model 134. Also, this contract rule adds an additional transition to the transactional layer to capture the exception situation. FIG. 11 shows an initial transactional layer state model and a customized transactional layer model based on the above contract rule. As shown, the TPCM 112 has customized the initial state model 1100 with a new transition 1104 resulting in the customized state model 1102. The TPCM 112 then generates a formal specification 1200 of the message layer state model using a markup language such as XML, as shown in FIG. 12. In FIG. 12, rules appear as guard conditions for transitions, with the rules themselves expressed using SBVR notation.

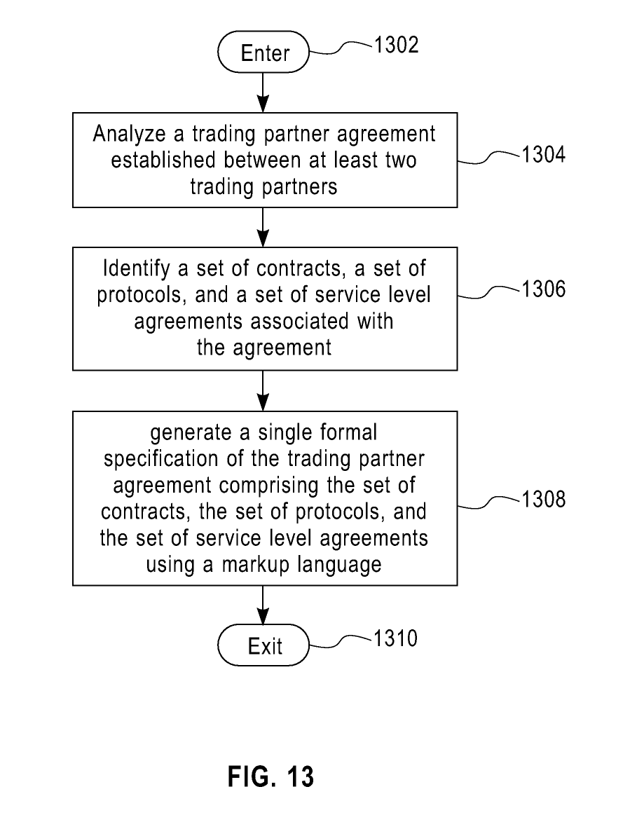

FIG. 13 is a flow diagram illustrating a process for generating a formal specification of a trading partner agreement according to one embodiment of the present invention. The flow diagram of FIG. 13 starts at step 1202 and flows directly to step 1204. The TPCM 112, at step 1204, analyzes a trading partner agreement 116 established between at least two trading partners. The TPCM 112, at step 1206, identifies a set of contracts 118, a set of protocols 120, and a set of service level agreements 122 associated with the agreement 116. The TPCM, at step 1208, generates a single formal specification 126 of the trading partner agreement 116. The formal specification 126 includes the set of contracts 118, the set of protocols 120, and the set of service level agreements 122 expressed in a markup language. Each set of contracts 118, protocols 120, and service level agreements 122 are expressed in a markup language notation. The single formal specification 126 is usable by multiple trading partners.

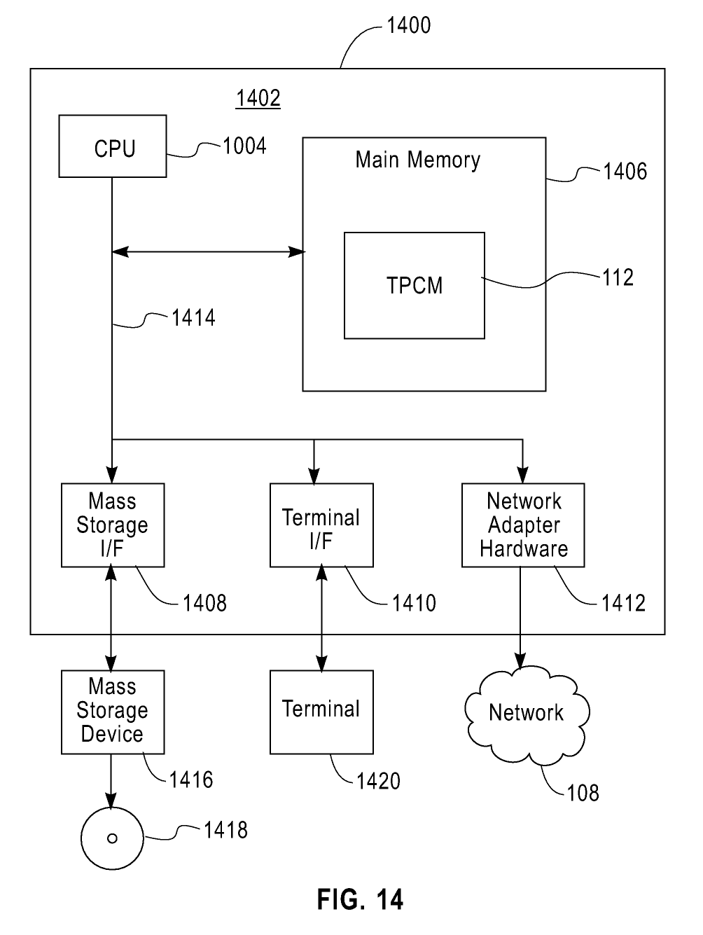

FIG. 14 is a block diagram illustrating an information processing system that is useful for implementing embodiments of the present invention. The information processing system 1300 is a suitably configured processing system adapted to implement an embodiment of the present invention. Any suitably configured processing system is able to be used, such as a personal computer, workstation, or the like.

This exemplary information processing system 1300 includes a computer 1302. The computer 1302 has a processor 1304 that is connected to a main memory 1306, a mass storage interface 1308, a terminal interface 1310, and network adapter hardware 1312. A system bus 1314 interconnects these system components. The mass storage interface 1308 is used to connect mass storage devices, such as data storage device 1316, to the information processing system 1300. One specific type of data storage device is a disk drive that can store data to and read data from a computer readable medium, such as an optical disk 1318 or a magnetic disk.

The main memory 1306, in this embodiment, includes, among other things, the TPCM 112 and its components. Although illustrated as concurrently resident in the main memory 1306, these are not required to be completely resident in the main memory 1306 at all times or even at the same time. In this embodiment, the information processing system 1300 utilizes conventional virtual addressing mechanisms to allow programs to behave as if they have access to a large, single storage entity, referred to as computer system memory, instead of access to multiple, smaller storage entities such as the main memory 1306 and data storage device 1316. The term “computer system memory” thus generically refers to the entire virtual memory of the information processing system 1300.

Although only one CPU 1304 is illustrated for computer 1302, computer systems with multiple CPUs can be used equally effectively. This embodiment of the present invention further incorporates interfaces that each includes separate, fully programmed microprocessors that are used to off-load processing from the CPU 1304. Terminal interface 1310 is used to directly connect one or more terminals 1320 to computer 1302 to provide a user interface to the computer 1302. These terminals 1320, which are able to be non-intelligent or fully programmable workstations, are used to allow system administrators and users to communicate with the information processing system 1300. The terminal 1320 is also able to be a user interface and peripheral devices that are connected to computer 1302 and controlled by terminal interface hardware included in the terminal interface 1310 that includes video adapters and interfaces for keyboards, pointing devices, and the like.

An operating system is included in the main memory, and is preferably a suitable multitasking operating system. However, further embodiments of the present invention use any other suitable operating system. Some embodiments of the present invention utilize an architecture, such as an object oriented framework mechanism, that allows instructions of the components of operating system to be executed on any processor located within the information processing system 1300. The network adapter hardware 1312 is used to provide an interface to a network 110. Embodiments of the present invention are able to be adapted to work with any data communications connections including present day analog and/or digital techniques or a future networking mechanism.

Although this exemplary embodiment of the present invention is described in the context of a fully functional computer system, further embodiments are capable of being distributed as a program product via a tangible computer readable medium (such as a CD, DVD, diskette, flash memory device, or other form of recordable media), or via any type of electronic transmission mechanism.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for generating a formal specification of a trading partner agreement for sharing between a plurality of trading partners, the method comprising the steps of:
analyzing the trading partner agreement that is established between at least two of the trading partners;
identifying a set of contracts, a set of protocols, and a set of service level agreements associated with the trading partner agreement; and
generating a single formal specification of the trading partner agreement,
wherein the single formal specification comprises the set of contracts, the set of protocols, and the set of service level agreements using a markup language, each of the set of contracts, the set of protocols, and the set of service level agreements are expressed in a markup language notation, and the single formal specification is usable by the plurality of trading partners.

2. The method of claim 1, wherein the generating step comprises generating the single formal specification in at least one of a human readable form and a machine readable form.

3. The method of claim 1, wherein the markup language notation expresses collaboration state transitions constrained by business rules that are defined with respect to a semantic model.

4. The method of claim 1, wherein the generating step comprises formally expressing admissible trading partner interaction patterns in a multi-layered specification.

5. The method of claim 4, wherein the rules are created based on a semantic model that expresses historical and current message data together with message structure.

6. The method of claim 1, wherein the generating step comprises expressing the set of contracts, the set of protocols, and the set of service level agreements as each relates to trading partner business-to-business messages.

7. The method of claim 1, further comprising the steps of:
receiving at least one trading partner business-to-business message;
identifying the set of contracts, the set of protocols, and the set of service level agreements within the single formal specification that is to be applied to the at least one trading partner business-to-business message; and
enforcing the set of contracts, the set of protocols, and the set of service level agreements with respect to the at least one trading partner business-to-business message.

8. The method of claim 7, wherein the receiving, identifying, and enforcing steps are performed by one information processing system and the generating step is performed by a different information processing system.

9. An information processing system for generating a formal specification of a trading partner agreement for sharing between a plurality of trading partners, the information processing system comprising:
a memory;
a processor communicatively coupled to the memory; and
a trading partner collaboration agreement manager (TPCM) communicatively coupled to the memory and the processor, the TPCM being adapted to:
analyze the trading partner agreement that is established between at least two of the trading partners;
identify a set of contracts, a set of protocols, and a set of service level agreements associated with the trading partner agreement; and
generate a single formal specification of the trading partner agreement,
wherein the single formal specification comprises the set of contracts, the set of protocols, and the set of service level agreements using a markup language, each of the set of contracts, the set of protocols, and the set of service level agreements are expressed in a markup language notation, and the single formal specification is usable by the plurality of trading partners.

10. The information processing system of claim 9, wherein the TPCM generates the single formal specification in at least one of human readable form and machine readable form.

11. The information processing system of claim 9, wherein the markup language notation expresses collaboration state transitions constrained by business rules that are defined with respect to a semantic model.

12. The information processing system of claim 9, wherein TPCM generates the single formal specification by formally expressing admissible trading partner interaction patterns at a message exchange level, a collaboration level, and a business transaction level along with rules that govern transitions in the interaction patterns.

13. The information processing system of claim 9, wherein the TPCM generates the single formal specification by expressing the set of contracts, the set of protocols, and the set of service level agreements as each relates to trading partner business-to-business messages.

14. The information processing system of claim 9, wherein the TPCM is further adapted to:
receive at least one trading partner business-to-business message;
identify the set of contracts, the set of protocols, and the set of service level agreements within the single formal specification that is to be applied to the at least one trading partner business-to-business message; and
enforce the set of contracts, the set of protocols, and the set of service level agreements with respect to the at least one trading partner business-to-business message.

15. A computer program product for generating a formal specification of a trading partner agreement for sharing between a plurality of trading partners, the computer program product comprising instructions for:
analyzing the trading partner agreement that is established between at least two of the trading partners;
identifying a set of contracts, a set of protocols, and a set of service level agreements associated with the trading partner agreement; and
generating a single formal specification of the trading partner agreement,
wherein the single formal specification comprises the set of contracts, the set of protocols, and the set of service level agreements using a markup language, each of the set of contracts, the set of protocols, and the set of service level agreements are expressed in a markup language notation, and the single formal specification is usable by the plurality of trading partners.

16. The computer program product of claim 15, wherein the markup language notation expresses collaboration state transitions constrained by business rules that are defined with respect to a semantic model.

17. The computer program product of claim 15, wherein the instructions for generating the single formal specification comprise instructions for formally expressing admissible trading partner interaction patterns at a message exchange level, a collaboration level, and a business transaction level along with rules that govern transitions in the interaction patterns.

18. The computer program product of claim 17, wherein the rules are created based on a semantic model that expresses historical and current message data together with message structure.

19. The computer program product of claim 15, wherein the instructions for generating the single formal specification comprise instructions for expressing the set of contracts, the set of protocols, and the set of service level agreements as each relates to trading partner business-to-business messages.

20. The computer program product of claim 15, further comprising instructions for:
receiving at least one trading partner business-to-business message;
identifying the set of contracts, the set of protocols, and the set of service level agreements within the single formal specification that is to be applied to the at least one trading partner business-to-business message; and
enforcing the set of contracts, the set of protocols, and the set of service level agreements with respect to the at least one trading partner business-to-business message.
